(19) United States
(12) Patent Application Publication
(10) Pub. No.: US 2019/0114848 A1
(43) Pub. Date: Apr. 18, 2019

(54) Process and system in which the user can request independent service providers to provide and replace flat tires on a roadside

(71) Applicant: Sheb Havens, Fort Worth, TX (US)

(72) Inventor: Sheb Havens, Fort Worth, TX (US)

(21) Appl. No.: 15/787,290

(22) Filed: Oct. 18, 2017

(51) Int. Cl. G07C 5/00; G06Q 10/00; H04W 4/029; G06F 3/048; G06Q 20/38; G06Q 10/06

(52) U.S. Cl. CPC G07C 5/008; G06Q 10/20; G06Q 10/06311; G06F 3/048; G06Q 20/38; H04W 4/029

(57) ABSTRACT

This current invention is a system and application that is aimed to make it easy for people to continue travelling after a tire goes flat. The system allows a service user to purchase a tire from a nearby store and request that a local roadside assistant agent deliver and change the tire. The local service providers are able to use the system to be alerted to job requests, see where tires are in stock, and find the location of clients.

### CROSS-REFERENCES TO RELATED APPLICATIONS (IF ANY)

None

### BACKGROUND

### 1. Field of the Invention

The present invention relates to a process to record and generate roadside tire delivery and replacement services.

### 2. Description of Prior Art

Currently, there are no applications on the market that allow independent truck drivers and standard individual drivers to request a tire be delivered and replaced at a roadside incident. While larger trucking fleets can have this service provided by calling contracted service providers, there is so similar option for independent drivers to call. There is no application on the market for any size user.

There is still room for improvement in the art.

### SUMMARY OF THE INVENTION

The current invention is system and application in which the user can request roadside delivery and replacement of a tire, by independent roadside contractors. This patent will include each user feature separate from the other or combined.

The system, in the preferred embodiment, would work like a smartphone application, this product would be available through the respective marketplace for smartphones.

The process would be that a user would register and login. They would either request roadside tire service or be a service provider. When a user requests roadside service, the user provides vehicle information, provides location, and has the option to search available tire stock and select a specific available tire. User pays for service through the system by credit card. Service providers will be alerted of requests. Service user can select jobs based on location of the request and where available tire stock is.

The user may also use the system to search for tires in stock at nearby stores.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample of a registration screen;

FIG. 4 displays the home screen;

FIG. 5 displays the location screen;

FIG. 6 shows a picture of the desired tire;

FIG. 7 shows a picture of the desired tire;

FIG. 8 shows a search function for tires;

FIG. 9 shows existing orders;

FIG. 10 shows specific order details;

FIG. 11 displays a payment screen;

FIG. 12 shows a profile screen;

FIG. 13 shows car details and order details;

FIG. 14 shows Notifications, Location, Stock, Orders, and Hours of Operation screens;

FIG. 15 is an Orders screen;

FIG. 16 is a location screen;

FIGS. 17 and 18 are overview screens;

FIG. 19 displays where tires are in stock; and

FIGS. 20 and 21 are edit screens.

### DESCRIPTION OF THE PREFERRED EMBODIMENT

There are a number of significant design features and improvements incorporated within the invention.

The current invention is a system and application that would allow users to request roadside assistance to deliver and replace a tire.

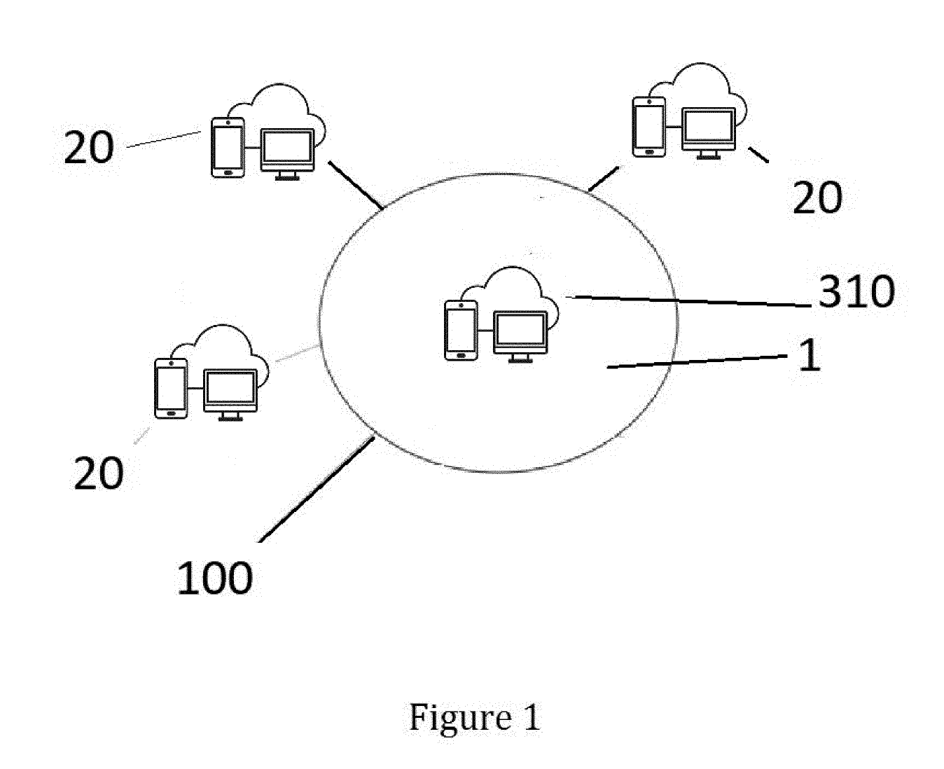

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

### Brief Overview

This current invention is a system 1 and application is aimed to make it easy for people to receive high quality roadside assistance when a tire goes flat while travelling. It is a system and computer application (app) in which the user can request delivery and replacement of a tire by independent roadside assistance providers. The system 1 will include each user feature separate from the other or combined.

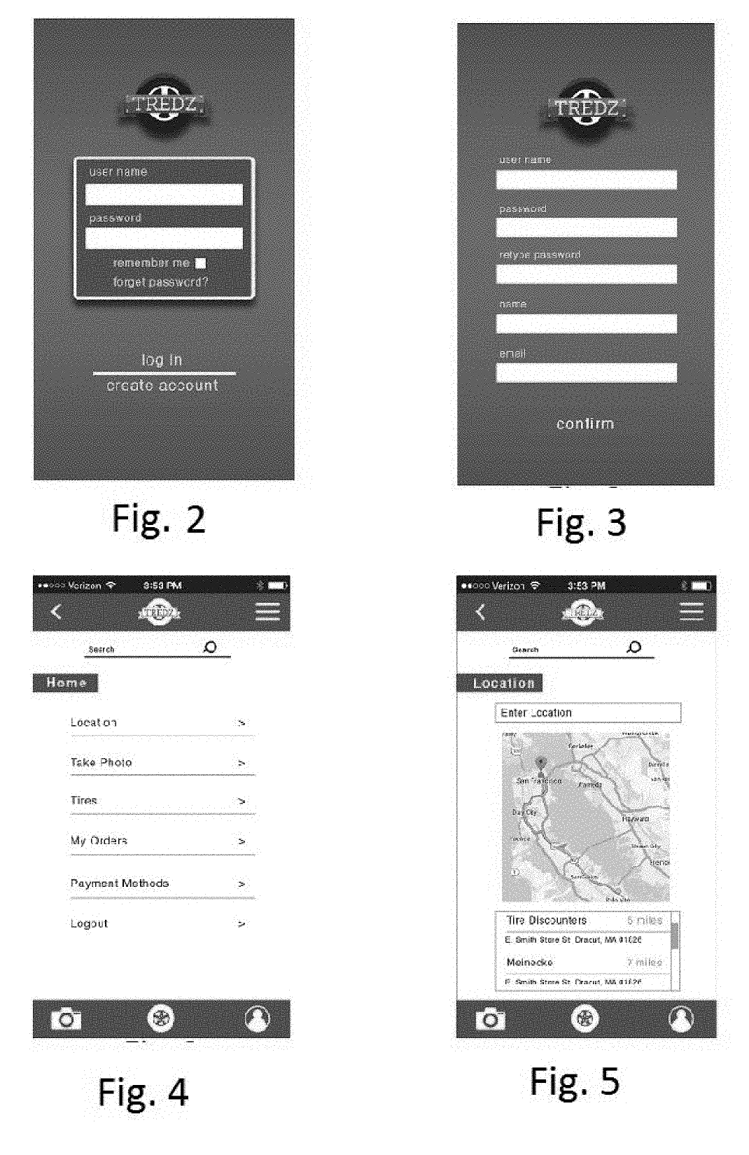

The users would sign-in directly or using social logins, as shown in FIG. 2, after the user registers the application, as shown in FIG. 3, as either a user or a service provider.

The user, from the Home screen, FIG. 4, can see and provide the location, take photos of the tire, search for tires in stock nearby, view orders, and manage payment methods. From the Location Screen, FIG. 5, the user can input a location or allow the app to use current location.

The system 1 can also use a GPS locator to know the location of the user. When a location is provided, the system 1 provides the nearby tire stores. The user will select a store after wards to order from and the user may begin an order.

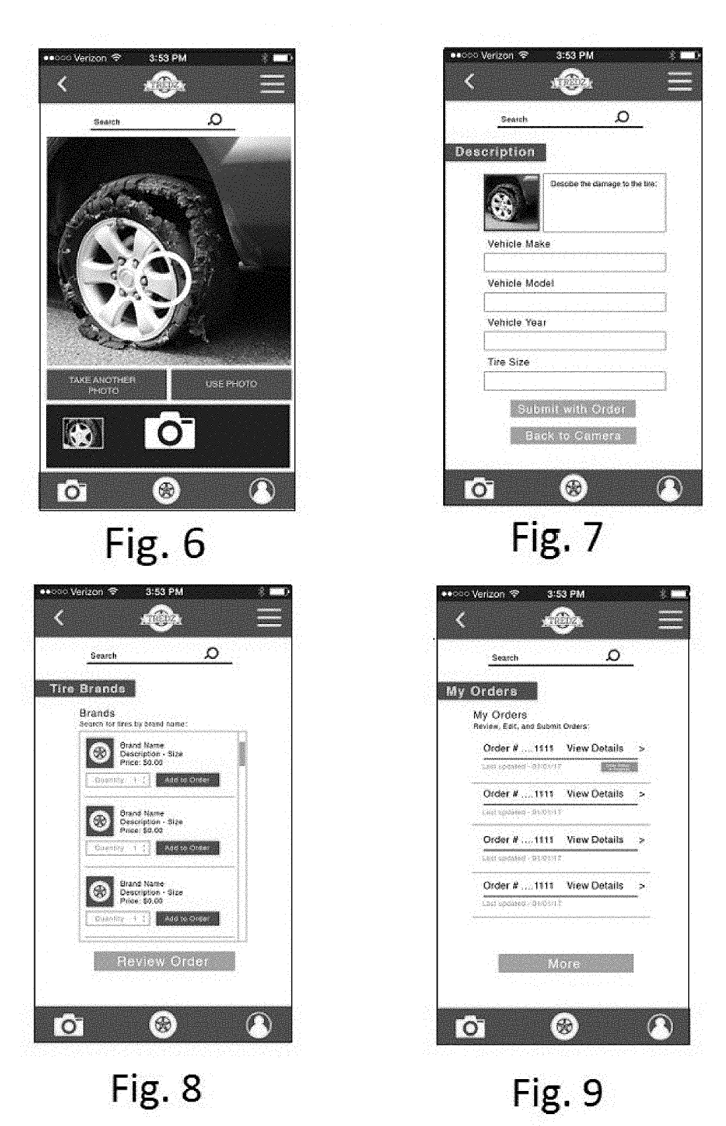

To begin selecting a tire type, the user may opt to take a picture of their tire as shown in FIG. 6. The user then fills a form to provide a description of the vehicle's tire (FIG. 7). The user can then search tires that match the tire on the system 1 (FIG. 8).

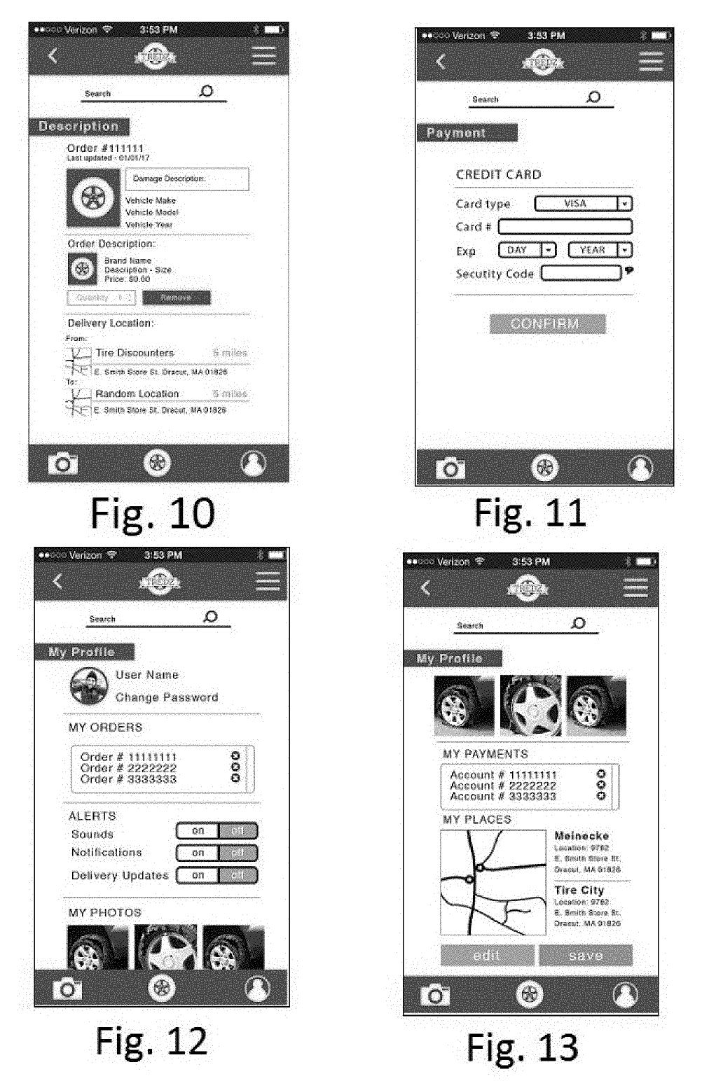

The user can then review existing orders as shown in FIG. 9 and specific order details as shown in FIG. 10.

User can manage payment through the system 1 with a credit card or other payment means (FIG. 11). The system 1 will take any standard payment such as credit card, electronic payment, wire transfer or check.

In the Profile, the user can view current order and adjust settings within the Profile (FIG. 12), as well as view car details, and order details (FIG. 13).

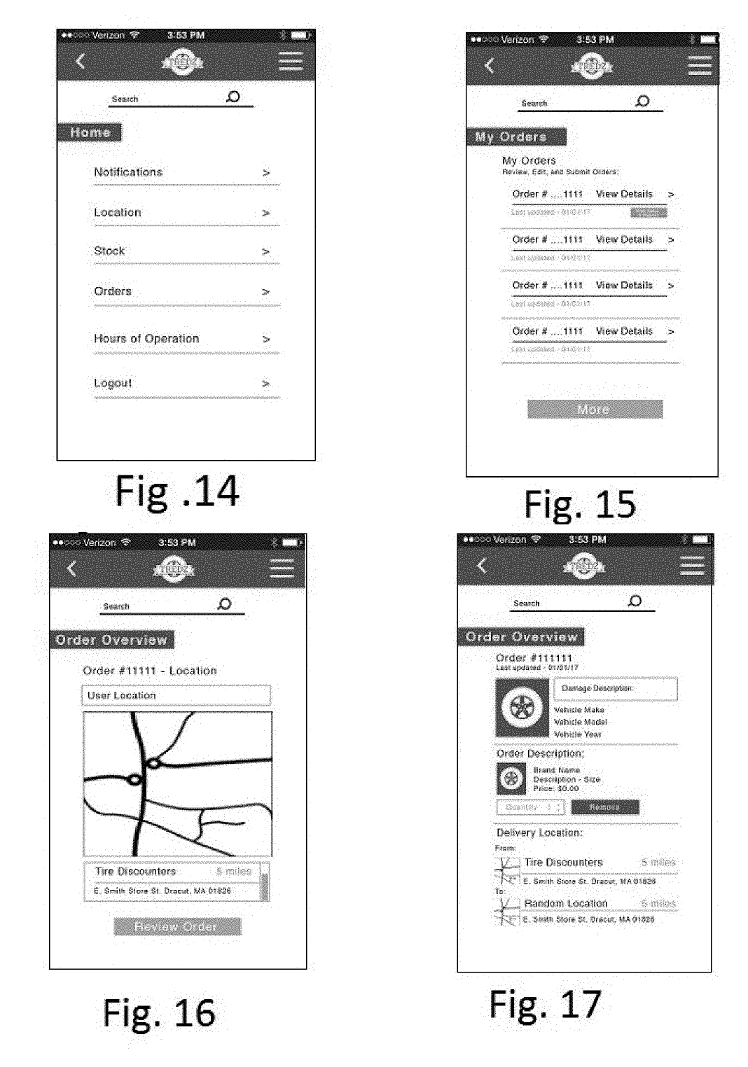

The service provider Home Screen (FIG. 14), allows the service user to go Notifications, Location, Stock, Orders, and Hours of Operation screens.

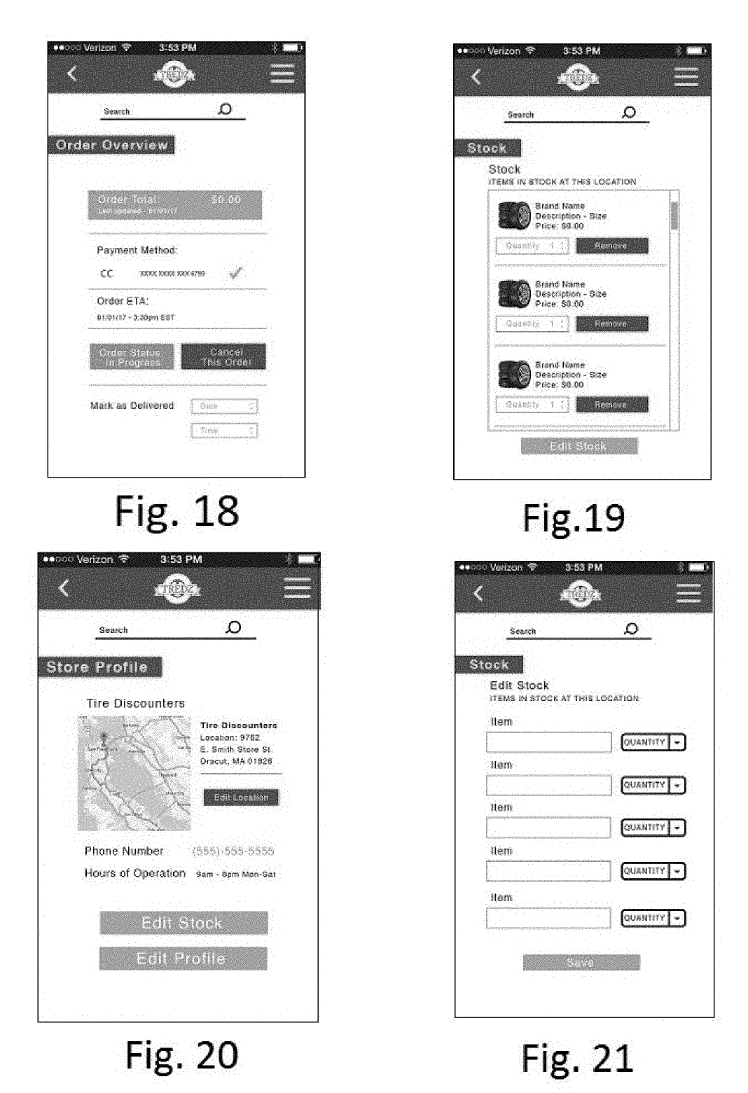

The Orders screen (FIG. 15) allows the service user to see orders, and select orders to see location (FIG. 16) and see the order overview (FIGS. 17 and 18). The service user can then see where tires are in stock (FIG. 19). Service providers can edit the store profile and tire stock for any affiliated tire stores (FIGS. 20 and 21).

### Operation

Users can submit and pay for job requests for roadside delivery and replacement of tires by independent roadside assistance operators. Service providers can select jobs to complete, pickup tires from store locations, and meet clients at roadside location.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
using a GPS system to find a location; providing information about the tire stores near that location, providing information about the desired tire, checking the tire store information to see if that tire is available, and ordering the tire.

2. A system according to claim 1 allowing the taking of a picture of the desired tire.

3. A system according to claim 1 having the users set up profiles.

4. A system according to claim 1 having
Having the user fill out a form to provide a description of the desired tire.

5. A system according to claim 1 allowing user to review existing orders and specific order details.

6. A system according to claim 1 managing payment through the system.

7. A system according to claim 1 having a service provide have access to the system.

8. A system according to claim 1 having a service provide deliver the ordered tire.

9. A system according to claim 7 having input the information.

10. A system according to claim 9 having the information be one or more of the following set price, location, inventory and hours of operation.

11. A system according to claim 7 where the service provider will deliver and install a tire ordered through the system.
